(19) United States
(12) Patent Application Publication
(10) Pub. No.: US 2016/0363184 A1
(43) Pub. Date: Dec. 15, 2016

(54) DAMPER

(71) Applicant: KYB Motorcycle Suspension Co., Ltd., Gifu (JP)

(72) Inventors: Nobuhiro NOGUCHI, Gifu (JP); Masashi SUMIDA, Gifu (JP)

(73) Assignee: KYB Motorcycle Suspension Co., Ltd., Gifu (JP)

(21) Appl. No.: 15/165,965

(22) Filed: May 26, 2016

(30) Foreign Application Priority Data
Jun. 11, 2015 (JP) 2015-118163

(51) Int. Cl. F16F 9/06; F16F 9/43; F16F 13/00; F16F 9/58

(52) U.S. Cl. CPC F16F 9/062; F16F 9/585; F16F 9/43; F16F 13/002; B62K 25/283

(57) ABSTRACT

A damper includes a cylinder, a rod movably inserted in the cylinder, a tube member connected to the rod and forming a first air chamber that is enlarged and reduced in capacity by relative movement of the cylinder and the rod, a bracket provided at an end portion of the rod protruding from the cylinder, a first air passage formed in the bracket and the rod and communicating with the first air chamber, and an air valve attached to the bracket to be provided at an end portion of the first air passage on one side.

### CROSS-REFERENCE TO RELATED APPLICATIONS

This application is based on and claims the benefit of priority from Japanese Patent Application No 2015-118163, filed on Jun. 11, 2015, the entire contents of which are incorporated herein by reference.

### BACKGROUND OF THE INVENTION

Technical Field

The present invention relates to a damper.

Related Art

Dampers are used as rear cushion units for supporting rear wheels of saddled vehicles such as two-wheeled vehicles or three-wheeled vehicles. The rear cushion units include a pneumatic spring-type rear cushion unit having a gas spring for elastically supporting a vehicle body, using the elastic force of gas, as disclosed in JP 2001-501155 A, FIGS. 9 and 10, for example.

### SUMMARY OF THE INVENTION

A rear shock absorber described in JP 2001-501155 A includes an upper cylindrical member and a lower cylindrical member in cylindrical shapes telescopically slidable on each other, a piston rod connected to the upper cylindrical member to move into and out of the lower cylindrical member, a first chamber formed between the piston rod and the upper cylindrical member, a second chamber formed between overlap portions of the upper cylindrical member and the lower cylindrical member, and a compressor piston fitted on the outer periphery of the lower cylindrical member to partition the first and second chambers. The first chamber is filled with gas to function as a positive spring for biasing the rear shock absorber in an extension direction. In addition, the second chamber is filled with gas to function as a negative spring for biasing the rear shock absorber in a contraction direction.

This configuration allows the spring characteristics of the entire device to be changed by not only adjusting the pressure in the first chamber but also adjusting the pressure in the second chamber. In the rear shock absorber described in JP 2001-501155 A, a valve is provided at an end portion of the upper cylindrical member to supply and exhaust gas to and from the second chamber so that the spring characteristics can be changed.

However, when a valve for gas supply and exhaust is attached to a member surrounding a gas chamber such as a chamber as in the above conventional rear shock absorber, there is a fear that the pressure in the gas chamber cannot be adjusted. To explain in more detail, when a damper is a rear cushion unit, for example, the rear cushion unit is interposed between a frame constituting the skeleton of a vehicle body and a swing arm swingably connected to the frame for supporting a rear wheel. In particular, when the rear cushion unit is mounted to a motorized saddled vehicle, an air valve portion may be hidden by a frame or a peripheral part of a motor held on the frame, depending on the vehicle type. In this case, an air valve is inaccessible with the damper mounted to the vehicle. As a result, the adjustment of the pressure in a gas chamber becomes impossible. This trouble can occur not only in a case where a damper is a rear cushion unit.

Thus, the present invention has an object of providing a damper capable of preventing the adjustment of the pressure in a gas chamber from becoming impossible even in a mounted state.

A damper, a means to solve the problem in the present invention, includes a tube member connected to a rod and forming a gas chamber that is enlarged and reduced in capacity by relative movement of a cylinder and the rod, a bracket provided at an end portion of the rod protruding from the cylinder, a passage formed in the bracket and the rod and communicating with the gas chamber, and a gas supply and exhaust valve attached to the bracket to be provided at an end portion of the passage on one side.

### BRIEF DESCRIPTION OF THE DRAWINGS

FIG. 1 is a side view schematically illustrating a vehicle to which a rear cushion unit, a damper according to a first embodiment of the present invention, is mounted;

FIG. 2 is a longitudinal sectional view specifically illustrating the rear cushion unit, the damper according to the first embodiment of the present invention;

FIG. 3 is a sectional view, a portion (a) of FIG. 3 is an enlarged left-half sectional view illustrating a piston portion in FIG. 2, a portion (b) of FIG. 3 is a right-half sectional view illustrating the rear cushion unit slightly contracted from a state in the portion (a) of FIG. 3; and

FIG. 4 is an enlarged view illustrating an upper bracket portion in FIG. 2.

### DESCRIPTION OF THE EMBODIMENTS

Hereinafter an embodiment of the present invention will be described with reference to the drawings. The same reference numerals provided through some drawings denote the same components.

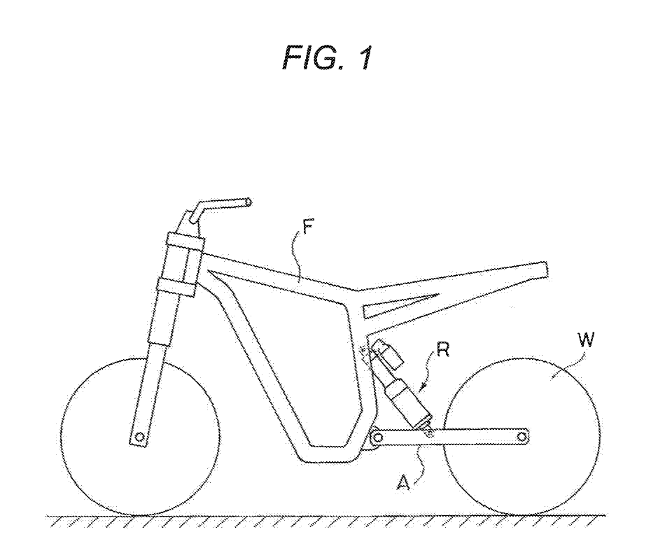

As illustrated in FIG. 1, a damper according to a first embodiment of the present invention is a rear cushion unit R mounted to a motorcycle, and is interposed between a frame F constituting the skeleton of a vehicle body and a swing arm A swingably connected to a rear portion of the frame F for supporting a rear wheel W. Although FIG. 1 schematically illustrates the rear cushion unit R mounted to the motorcycle, the rear cushion unit R according to the present invention may be mounted to three-wheeled vehicles or other saddled vehicles. The rear cushion unit R may be mounted in any position in any manner if shocks due to road unevenness input to the rear wheel W can be softened by the rear cushion unit R.

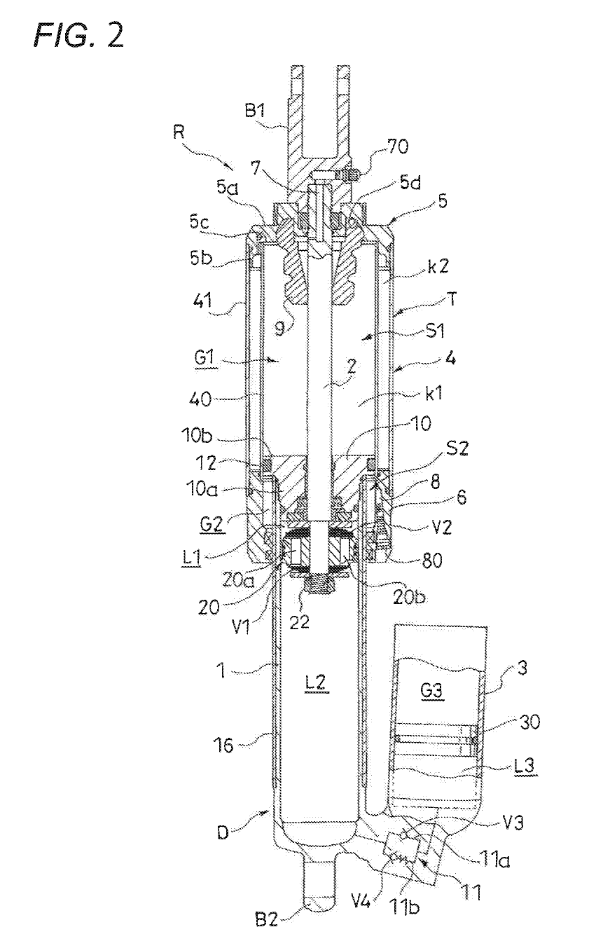

As illustrated in FIG. 2, the rear cushion unit R includes a damper body D having a cylinder 1 and a rod. 2 that moves into and out of the cylinder 1, a tube member T connected to the rod 2 and forming a first air chamber G1 around the outer periphery of the rod 2 and also forming a second air chamber G2 around the outer periphery of the cylinder 1, and a pair of brackets B1, B2 provided at one end and the other end of the damper body D. The bracket B1 on the upper side in FIG. 2 is screwed. on an upper end portion of the rod 2 in FIG. 2 protruding from the cylinder 1, and is connected to the swing arm A. The other bracket B2 on the lower side in FIG, 2 is provided at the bottom of the cylinder 1, and is connected to the frame F. When a shock due to road unevenness is input to the rear wheel W, the rod 2 moves into or out of the cylinder 1, and the rear cushion unit R extends or contracts.

In the present embodiment, the rear cushion. unit R is of an inverted type with the rod 2 connected to the wheel side and the cylinder 1 connected to the vehicle body side. In the mounted state, the rod 2 of the rear cushion unit R extends downward of the cylinder 1. However, the rear cushion unit F may be of an upright type with the rod 2 connected to the vehicle body side and the cylinder 1 connected to the wheel side.

The damper body D includes the above-described cylinder 1 and rod 2, an annular rod guide 10 provided at an upper end portion of the cylinder 1 in FIG. 2 for axially slidably supporting the rod 2, a piston 20 slidably inserted in the cylinder 1 and attached to a lower end portion of the rod 2 in FIG. 2, a tank 3 provided outside the cylinder 1 side by side with the cylinder 1, a base valve 11 partition the interior of the cylinder 1 and the interior of the tank 3, and a free piston 30 slidably inserted in the tank 3.

The cylinder 1 has a bottomed cylindrical shape. In the cylinder 1, an extension-side chamber L1 on the rod 2 side and a compression-side chamber L2 on the piston 20 side partitioned by the piston 20 are formed. In the tank 3, a liquid chamber L3 and a gas chamber G3 partitioned by the free piston 30 are formed. The compression-side chamber L2 and the liquid chamber L3 are partitioned by the base valve 11. The extension-side chamber L1 the compression-side chamber L2, and the liquid chamber L3 are filled with hydraulic oil, and the gas chamber G3 is filled with air. An air valve not shown for supplying and exhausting air to and from the gas chamber G3 is attached to the tank 3 so that the pressure in the gas chamber G3 can be adjusted.

The rod guide 10 provided at the upper end portion of the cylinder 1 in FIG. 2 has a bolt portion 10a screwed into the cylinder 1, and a flange portion 10b of an outside diameter larger than the outside diameter of the bolt portion 10a, extending outward of the cylinder 1. An O-ring 12 that slidably contacts an inner peripheral surface of a first chamber member 40 of the tube member T and seals a gap between the rod guide 10 and the first chamber member 40 is provided on the outer periphery of the flange portion 10b. Thus, in the present embodiment, the flange portion 10b can partition the first air chamber G1 and the second air chamber G2. Specifically, in the present embodiment, a piston for partitioning gas chambers (air piston) is the flange portion 10b seamlessly integrated with the rod guide 10, and is a part of the rod guide 10, so that the number of components and assembly man-hours of the rear cushion unit R can be reduced. However, the air piston only needs to be able to partition the first air chamber G1 and the second air chamber G2 without axially moving relative to the cylinder 1. Therefore, the air piston may be seamlessly integrated with the cylinder 1, or the air piston may be formed separately from the rod guide 10 and the cylinder 1, and connected to the cylinder 1 or the rod guide 10 by fitting, welding, bonding, or the like.

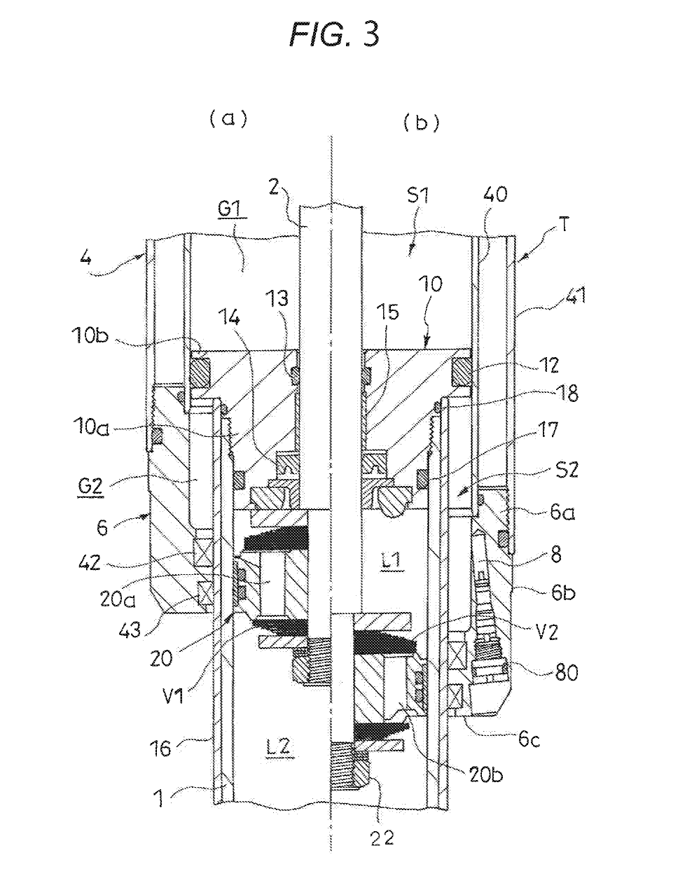

As illustrated in FIG. 3, an O-ring 13 and a U-packing 14 are provided on the inner periphery of the rod guide 10 for closing the outer periphery of the rod 2. The O-ring 13 prevents air in the first air chamber G1 from entering the cylinder 1, and the U-packing 14 prevents hydraulic oil in the cylinder 1 from flowing out to the first air chamber G1 side. An annular bush 15 is provided between the O-ring 13 and the U-packing 14 to allow the rod 2 to smoothly slide on the rod guide 10. Further, O-rings 17, 18 are provided on the outer periphery of the rod guide 10 to seal a gap between the cylinder 1 and the rod guide 10 and also to seal a gap between a cylindrical slide pipe 16 covering the outer periphery of the cylinder 1 and the rod guide 10.

The piston 20 that partitions the interior of the cylinder 1 into the extension-side chamber L1 and the compression-side chamber L2 is formed with an extension-side flow path 20a and a compression-side flow path 20b that connect the extension-side chamber L1 and the compression-side chamber L2. An extension-side leaf valve V1 for opening and closing the outlet of the extension-side flow path 20a is placed on the lower end of the piston 20 in FIG. 3. On the other hand, a compression-side leaf valve V2 for opening and closing the outlet of the compression-side flow path 20b is placed on the upper end of the piston 20 in FIG. 3. The extension-side leaf valve V1 and the compression-side leaf valve V2 are both annular plates, and are fixed to the distal end of the rod 2 by a piston nut 22 together with the piston 20, and are allowed to bend on the outer peripheral side. Therefore, the extension-side leaf valve V1, when bending under the pressure of the extension-side chamber L1, can open the extension-side flow path 20a, and the compression-side leaf valve V2, when bending under the pressure of the compression-side chamber L2, can open the compression-side flow path 20b.

The base valve 11 partitioning the interior of the cylinder 1 and the interior of the tank 3 includes, as shown by hydraulic symbols in FIG. 2, a suction flow path 11a and a discharge flow path 11b that connect the compression-side chamber L2 and the liquid chamber L3. A check valve V3 is provided in the suction flow path 11a, and permits only the flow of hydraulic oil from the liquid chamber L3 toward the compression-side chamber L2 through the suction flow path 11a. A damping valve V4 is provided in the ocher discharge flow path 11b, and permits only the flow of hydraulic oil from the compression-side chamber L2 toward the liquid chamber L3 through the discharge flow path 11b, and provides a resistance to the flow.

According to the above configuration, when the rear cushion unit R extends, the rod 2 moves upward in FIG. 2 relative to the cylinder 1, and the piston 20 moves upward in FIG. 2 in the cylinder 1, compressing the extension-side chamber L1 and enlarging the compression-side chamber L2.

Then, the pressure in the extension-side chamber L1 compressed increases, and hydraulic oil in the extension-side chamber L1 pushes open the extension-side leaf valve V1 and passes through the extension-side flow path 20a, moving to the compression-side chamber L2. An the cylinder 1, although hydraulic oil becomes short by the rod volume that has exited from the cylinder 1, the check valve V3 opens so that hydraulic oil commensurate with the shortage is supplied from the liquid chamber L3 to the compression-side chamber L2 through the suction flow path 11a. Since the extension-side leaf valve V1 provides a resistance to the flow of hydraulic oil from the extension-side chamber L1 toward the compression-side chamber L2, the pressure of the extension-side chamber L1 increases. In contrast, the compression-side chamber L2 is supplied with hydraulic oil from the liquid chamber L3, and thus has a pressure substantially equal to that in the tank 3, Therefore, a difference in pressure occurs between the extension-side chamber L1 and the compression-side chamber L2. The differential pressure is applied to the piston 20, and the damper body D exerts a damping force to suppress the extending action of the rear cushion unit R.

On the contrary, when the rear cushion unit R contracts, the rod 2 moves downward in FIG. 2 relative the cylinder 1, and the piston 20 moves downward in FIG. 2 in the cylinder 1, compressing the compression-side chamber L2 and enlarging the extension-side chamber L1.

Then, the pressure in the compression-side chamber L2 compressed increases, and hydraulic oil in the compression-side chamber L2 pushes open the compression-side leaf valve V2 and passes through the compression-side flow path 20b, moving to the extension-side chamber L1. In the cylinder 1, although hydraulic oil becomes surplus by the rod volume that has entered. in the cylinder 1, the surplus hydraulic oil pushes open the damping valve V4 and passes through the discharge flow path 11b, being discharged from the compression-side chamber L2 to the liquid chamber L3. Thus, the compression-side leaf valve V2 and the damping valve V4 provide resistances to the flow of hydraulic oil from the compression-side chamber L2 toward the extension-side chamber L1 and the liquid chamber L3, so that the pressure of the compression-side chamber L2 increases. In contrast, the pressure in the extension-side chamber L1 enlarged decreases. Therefore, a difference in pressure occurs between the compression-side chamber L2 and the extension-side chamber L1. The differential pressure is applied to the piston 20, and the damper body D exerts a damping force to suppress the contracting action of the rear cushion unit R.

The structure of the damper body D is not limited to the above-described one, and can be changed as appropriate. For example, although hydraulic oil is used as a fluid for generating a damping force in the present embodiment, other fluids may be used. Gas sealed in the gas chamber G3 can also be changed as appropriate. The gas chamber G3 may be pressurized to eliminate the base valve 11. The cylinder 1 and the tank 3 may be connected axially into one piece to eliminate the tank 3 of a type placed separately from the cylinder 1 as in the present embodiment. Although the liquid chamber L3 and the gas chamber G3 are partitioned by the free piston 30, a bladder, a bellows, or the like may be used for the partition. The cylinder 1 may be formed by inner and outer two cylinders to provide the liquid chamber L3 and the gas chamber G3 between them to form the damper body D in a double-cylinder type. The rod 2 may be extended through both the extension-side chamber L1 and the compression-side chamber L2 to be of a double-rod type,

Next, the tube member T forming the first air chamber G1 and the second air chamber G2 around the outer periphery of the damper body includes, as illustrated in FIG. 2, a double-cylinder portion 4 having the first chamber member 40 and the second chamber member 41 in cylindrical shapes, constituting inner and outer two cylinders, a chamber holder 5 closing an upper opening of the double-cylinder portion 4 in FIG. 2, and a sealing member 6 closing a lower opening of the double-cylinder portion 4 in FIG. 2. The chamber holder 5 has an annular top portion 5a with a hole (not denoted) through which the rod 2 can be inserted, and an annular insertion portion 5b extending downward in FIG. 2 from the outer periphery of the top portion 5a and inserted between the first chamber member 40 and the second chamber member 41.

As illustrated in FIG. 3, the sealing member 6 has an annular insertion portion 6a inserted between the first chamber member 40 and the second chamber member 41, a cylindrical portion 6b extending downward in FIG. 3 from the insertion portion 6a, and an annular diameter-reduced portion 6c protruding on the inner peripheral side from the lower end of the cylindrical portion 6b in FIG. 3. Annular seals 42, 43 that slidably contact an outer peripheral surface of the slide pipe 16 and seal a gap between the slide pipe 16 and the sealing member 6 are provided on the inner periphery of the diameter-reduced portion 6c. That is, in the present embodiment, the diameter-reduced portion 6c functions as a sliding portion that slidably contacts an outer peripheral surface of the cylinder 1 via the slide pipe 16.

As illustrated in FIGS. 2 and 3, the second chamber member 41 constituting a part of the double-cylinder portion 4 has its upper end portion in FIG. 2 screwed on the outer periphery of the insertion portion 5b of the chamber holder 5, and has its lower end portion in FIG. 2 screwed on the outer periphery of the insertion portion 6a (FIG. 3) of the sealing member 6. The other first chamber member 40 has its upper end portion in FIG. 2 inserted in the insertion portion 5b, and has its lower end portion in FIG. 2 inserted in the insertion portion 6s (FIG. 3) and is interposed between the top portion 5a of the chamber holder 5 and a step formed at an end of the insertion portion 6a of the sealing member 6. Thus, the first chamber member 40, the second chamber member 41, the chamber holder 5, and the sealing member 6 are integrated as the tube member T. Since the top portion 5a of the chamber holder 5 is fitted on the outer periphery of a lower end portion of the bracket B1 in FIG. 2, the tube member T can axially move together with the rod 2 relative to the cylinder 1.

A groove 5c forming a gap between the chamber holder 5 and the first chamber member 40 is provided in an inside surface of the chamber holder 5. A space k1 between the rod 2 and the first chamber member 40 communicates with a space k2 between the first chamber member 40 and the second chamber member 41 via the gap. Both the spaces k1, k2 are filled with air. The combined space of both the spaces k1, k2 constitutes the first air chamber G1. A space formed around the slide pipe 16 covering the outer periphery of the cylinder 1, enclosed by the flange portion 10b of the rod guide 10, the first chamber member 40, and the cylindrical portion 6b (FIG. 3) and the diameter-reduced portion 6c (FIG. 3) of the sealing member 6 is filled with air. The space constitutes the second air chamber G2.

As illustrated in FIGS. 2 to 4, a gap between the top portion 5a of the chamber holder 5 and the rod 2, a gap between the insertion portion 5b and the second chamber member 41, a gap between the insertion portion 6a of the sealing member 6 and the second chamber member 41, and a gap between the insertion portion 6a and the first chamber member 40 are sealed by O-rings (not denoted), individually. As described above, the gap between the rod 2 and the rod guide 10, and the gap between the rod guide 10 and the slide pipe 16 are sealed by the O-rings 13, 18. Further, the gap between the first chamber member 40 and the flange portion 10b is sealed by the O-ring 12 that slidably contacts the inner peripheral surface of the first chamber member 40, and the gap between the slide pipe 16 and the diameter-reduced portion 6c is sealed by the seals 42, 43 that slidably contact the outer peripheral surface of the slide pipe 16. Therefore, air in the first air chamber G1 and the second air chamber G2 does not leak to the atmosphere side or into the cylinder 1, and the first air chamber G1 and the second air chamber G2 can be sealed spaces, individually, for partition thereof.

According to the above configuration, the first air chamber G1 functions as a main spring S1 for biasing in a direction to enlarge the capacity of the first air chamber G1, that is, in a direction to extend the rear cushion unit R by the elastic force of air sealed inside. The other second air chamber G2 functions as a balance spring S2 for biasing in a direction to enlarge the capacity of the second air chamber G2, that is, in a direction to contract the rear cushion unit R by the elastic force of air sealed inside.

When the rear cushion unit R extends, the tube member T moves upward in FIG. 2 together with the rod 2 relative to the cylinder 1, so that the capacity of the first air chamber G1 enlarges, and the capacity of the second air chamber G2 reduces. Therefore, the elastic force of the main spring S1 decreases, and the elastic force of the balance spring S2 increases. The extending action reduces the elastic force of the rear cushion unit R as a whole. On the contrary, when the rear cushion unit R contracts, the tube member T moves downward in FIG. 2 together with the rod 2 relative to the cylinder 1, so that the capacity of the first air chamber G1 reduces, and the capacity of the second air chamber G2 enlarges (a portion (b) of FIG. 3). Therefore, the elastic force of the main spring S1 increases, and the elastic force of the balance spring S2 decreases. The contracting action increases the elastic force of the rear cushion unit R as a whole. Thus, the rear cushion unit R elastically supports the vehicle body by the elastic force of an air spring by the first air chamber G1 and the second air chamber G2, and exerts an elastic force commensurate with the amount of the stroke of the rear cushion unit R.

In the present. embodiment, the rear cushion unit R has the main spring S1 and the balance spring S2 that bias it in opposite directions, thus being able to make the ride quality of the vehicle comfortable. To explain in more detail, although the vehicle body can be elastically supported only with the main spring S1, this results in the spring characteristics of the rear cushion unit as a whole constituted only by the characteristics of the main spring S1, having non-linear characteristics unique to air springs. Therefore, when the spring characteristics of the rear cushion unit are set to desired characteristics in the latter half of the stroke, the elastic force in the first half of the stroke, in particular, near the time of maximum extension can become excessive, degrading the ride quality. Thus, as in the present embodiment, the addition of the balance spring S2 can help contraction near the time of maximum extension of the rear cushion unit R, making the ride quality of the vehicle comfortable. In particular, it is preferable that the biasing force by the main spring S1 applied in the extension direction when the rear cushion unit R is at the time of maximum extension is offset by the balance spring S2 to approximate the combined characteristics of the main spring S1 and the balance spring S2 to the characteristics of a coil spring proportional to the stroke amount.

As shown in FIG. 2, a first air passage 7 communicating with the first air chamber G1 is formed from a side portion of the bracket B1 to a side portion of the rod 2, and a second air passage 8 communicating with the second air chamber G2 is formed in the sealing member 6. Air valves 70, 80 are provided to the first air passage 7 and the second air passage 8, respectively. Therefore, air can be supplied and exhausted using the air valves 70, 80 to adjust the pressure in the first air chamber G1 and the pressure in the second air chamber G2, thereby to set the spring characteristics of the rear cushion unit R to desired characteristics.

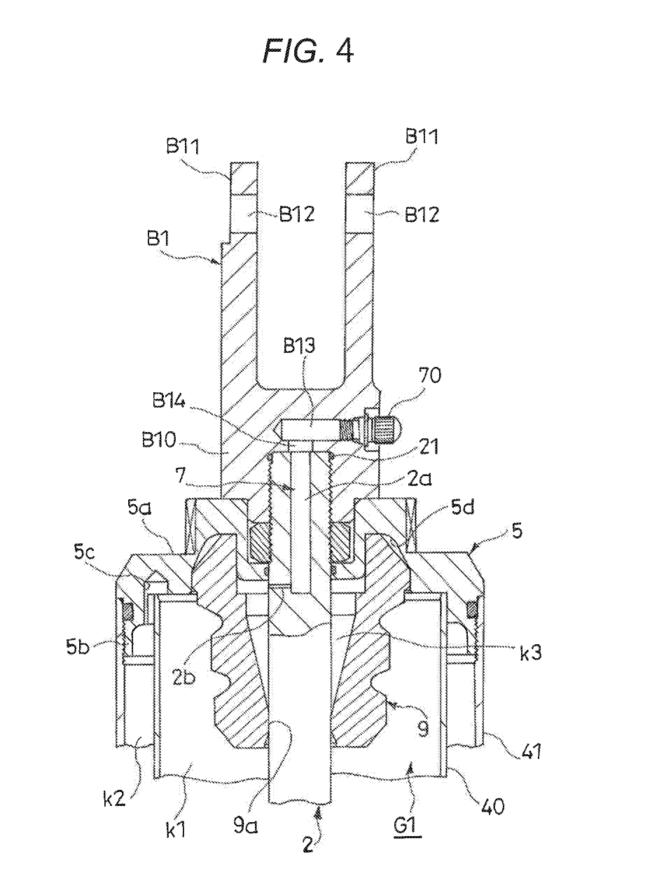

Next, the first air passage 7 will be described in more detail. The bracket B1 in which a part of the first air passage 7 is formed has, as shown in FIG. 4, a rod-side connection portion B10 in a topped cylindrical shape screwed on the outer periphery of an upper end portion of the rod 2 in FIG. 4, and a pair of wheel-side connection portions B11, B11 extending from a top portion of the rod-side connection portion B10 upward in FIG. 4. Mounting holes B12 used for connection to the swing arm A are formed in the wheel-side connection portions B11, B11, individually. A lateral hole B13 extending from an outer peripheral end of the bracket B1 to the radial center of the bracket B1, and a vertical hole B14 communicating with the lateral hole B13 and opening into the inside of a cylindrical portion of the rod-side connection portion B10 are formed in the top portion of the rod-side connection portion B10. The vertical hole B14 extends in a central portion of the bracket B1 along an axis line passing through the center of the rod 2. A vertical hole 2a extending from the upper end of the rod 2 in FIG. 2 downward and a lateral hole 2b extending from an outer peripheral end of the rod 2 to the radial center of the rod 2 and communicating with the vertical hole 2a are formed in an upper end portion of the rod 2 in FIG. 4. The vertical hole 2a of the rod 2 is provided. in a central portion of the rod 2 to face the vertical hole B14 of the bracket B1. The first air passage 7 includes the lateral hole B13 and the vertical hole B14 in the bracket B1 and the vertical hole 2a and the lateral hole 2b in the rod 2.

The air valve 70 is attached to a right end portion of the lateral hole B13 in FIG. 4 constituting an end portion of the first air passage 7 on the atmosphere side. Air supplied from the air valve 70 passes through the lateral hole B13, the vertical hole B14, the vertical hole 2a, and the lateral hole 2b in this order to be supplied to the first air chamber G1, so that the pressure in the first air chamber G1 can be increased. On the contrary, when the pressure in the first air chamber G1 is reduced, air in the first air chamber G1 conversely passes along the above-described route to be discharged to the atmosphere side. Since the gap between the rod 2 and the bracket B1 is sealed by an O-ring 21, air passing through the first air passage 7 does not leak to the atmosphere side.

Thus, in the present embodiment, the air valve 70 for supplying and exhausting air to and from the first air chamber G1 is attached to the bracket B1 used for mounting the rear cushion unit R to the vehicle. This makes the air valve 70 less likely to be hidden by the frame F or a peripheral part of a motor held on the frame F or the like. Therefore, the air valve 70 is accessible with the rear cushion unit R mounted to the vehicle, and does not become inaccessible, thus preventing the adjustment of the pressure in the first air chamber G1 from becoming impossible.

In the present embodiment, an annular groove 5d along a circumferential direction is formed in a lower portion of the top portion 5a of the chamber holder 5 in FIG. 4, and an upper end portion of a tubular bump cushion 9 in FIG. 4 is fitted in the annular groove 5d. The bump cushion 9 is a member having elasticity such as rubber, and, at the time of maximum compression of the rear cushion unit R, strikes the rod guide 10, elastically deforming, and softening an impact at the time of maximum compression. The inside diameter of the bump cushion 9 gradually decreases downward in FIG. 4, and the inner periphery of a diameter-reduced portion 9a provided at a lower end portion of the bump cushion 9 in FIG. 4 contacts the outer periphery of the rod 2. The left end of the lateral hole 2b in FIG. 4 constituting an opening of the first air passage 7 on the first air chamber G1 side faces an inner peripheral surface of the bump cushion 9. Air moving into and out of the first it chamber G1 always passes through a space k3 formed between the bump cushion 9 and the rod 2. Therefore, when air comes and goes between the inner peripheral side (space k3) and the outer peripheral side of the bump cushion 9, it passes through a gap formed between the bump cushion 9 and the chamber holder 5, or pushes open the diameter-reduced portion 9a of the bump cushion 9 and passes through a gap formed around the outer periphery of the rod 2. These gaps are narrow and inhibit the movement of air, thus when air is discharged from the first air chamber G1, they can prevent discharge of a large amount of air from the first air chamber G1 in a short period of time.

The configuration of the rear cushion unit R can be changed as appropriate. For example, a groove or the like may be formed in the bump cushion 9 or the chamber holder 5 to form a gap therebetween to enable quick supply and exhaust of air to and from the first air chamber G1. The bump cushion 9 may be changed to a coil spring, or the position of the bump cushion 9 may be changed. The bump cushion 9 may be eliminated if consideration is given to prevent causing significant degradation in ride quality by an impact at the time of maximum compression of the rear cushion unit R.

Although the first air chamber G1 and the second air chamber G2 are filled with air, individually, in the present embodiment, as used can be changed as appropriate if the first air chamber G1 or the second air chamber G2 can constitute a gas spring (pneumatic spring) using the elastic force of the gas. The gas may be the same as or different from gas in the gas chamber G3. In the present embodiment, the rear cushion unit R can be reduced in weight since the main spring S1 and the balance spring S2 are both air springs. Alternatively, the balance spring S2 may be changed to a coil spring. Further, in the present embodiment, the capacity of the first air chamber G1 can be increased since the first air chamber G1 includes the spaces k1, k2 . Alternatively, the first air chamber G1 may include only the space k1.

In the present embodiment, the slide pipe 16 is provided on the outer periphery of the cylinder 1 to form a structure to prevent the diameter-reduced portion 6c functioning as a sliding portion from directly slidably contacting the cylinder 1, and the sliding portion slidably contacts the outer periphery of the cylinder 1 via the slide pipe 16. Therefore, it is only necessary to smooth only the inner peripheral surface of the cylinder 1 for sliding, and the outer peripheral surface can remain rough, so that. the working of the cylinder 1 can be facilitated. However, the outer peripheral surface of the cylinder 1 may be smoothed to make the sliding portion directly slidably contact the outer periphery of the cylinder 1.

Hereinafter, the function and effect of the rear cushion unit R according to the present embodiment will be described.

In the present embodiment, the rear cushion unit (damper) R has the tubular bump cushion 9 provided on the outer periphery of the rod 2 for softening an impact at the time of maximum compression. The opening of the first air passage (passage) 7 on the first air chamber G1 side (the other side) faces the inner peripheral surface of the bump cushion 9. Therefore, air (gas) supplied and exhausted to and from the first air chamber (gas chamber) G1 through the first air passage (passage) 7 passes through the gap formed around the bump cushion 9, which can prevent discharge of a large amount of air (gas) from the first air chamber (gas chamber) G1 in a short period of time. The position at which the bump cushion 9 is provided can be changed as appropriate. The bump cushion 9 may be eliminated.

In the present embodiment, the rear cushion unit (damper) R includes the cylinder 1, the rod 2 movably inserted in the cylinder 1, the tube member T connected to the rod 2 and forming the first air chamber (gas chamber) G1 chat is enlarged and reduced in capacity by the relative movement, of the cylinder 1 and the rod 2, the bracket B1 provided at the end portion of the rod 2 protruding from the cylinder 1, the first air passage (passage) 7 formed in the bracket B1 and the rod 2 and communicating with the first air chamber (gas chamber) G1, and the air valve (can supply and exhaust valve) 70 attached to the bracket B1 and provided at the end portion of the first air passage (passage) 7 on the atmosphere side (one side).

The bracket B1 is a component used for mounting the rear cushion unit (damper) R to the vehicle. Thus, the air valve (gas supply and exhaust valve) 70, when attached to the bracket B1, is less likely to be hidden by the frame F or a peripheral part of a motor held on the frame F or the like. Therefore, the air valve 70 is accessible with the rear cushion unit R mounted to the vehicle, and does not become inaccessible, thus being able to prevent the adjustment of the pressure in the first air chamber (gas chamber) G1 from becoming impossible.

The tube member T may be directly connected to the rod 2 or may be indirectly connected via another member. The state where the tube member T is connected to the rod 2 includes both a case where it is directly connected and a case where it is indirectly connected, and may be either of them. This change is possible irrespective of the position at which the bump cushion 9 is provided and the presence or absence of the bump cushion 9.

What is claimed is:

1. A damper comprising:
a cylinder;
a rod movably inserted in the cylinder;
a tube member connected to the rod and forming a gas chamber that is enlarged and reduced in capacity by relative movement of the cylinder and the rod;
a bracket provided at an end portion of the rod protruding from the cylinder;
a passage formed in the bracket and the rod and communicating with the gas chamber; and
a gas supply and exhaust valve attached to the bracket to be provided at an end portion of the passage on one side.

2. The damper according to claim 1, further comprising:
a tubular bump cushion provided on an outer periphery of the rod, for softening an impact at time of maximum compression, wherein
the passage has an opening on the other side facing an inner peripheral surface of the bump cushion.
